(19) United States
(12) Patent Application Publication
(10) Pub. No.: US 2012/0006695 A1
(43) Pub. Date: Jan. 12, 2012

(54) CONTACT LENS DISTRIBUTION/STORAGE METHOD AND CONTACT LENS PACKAGE

(75) Inventors: Tetsuji Kawai, Kasugai-shi (JP); Yuji Ito, Ichinomiya-shi (JP)

(73) Assignee: MENICON CO., LTD., Nagoya-shi, Aichi (JP)

(21) Appl. No.: 13/256,027

(22) PCT Filed: Mar. 12, 2009
(86) PCT No.: PCT/JP2009/001114

§ 371 Date: Sep. 12, 2011

(51) Int. Cl. A45C 11/04; G02C 7/04; C09K 3/00

(52) U.S. Cl. 206/5.1; 252/182.11; 252/182.35; 252/182.32; 351/160 R

(57) ABSTRACT

A contact lens distribution/storage method with which contact lenses can be reliably stored in a small space. To achieve this with a method for storing contact lenses for distribution using a contact lens package containing a packaging solution and the contact lens, a soft contact lens is used as the contact lens. A fluid volume of the packaging solution is 0.1 to 1.0 mL, and a buffering capability of the packaging solution is 3 mmol/L or greater measured in buffering capacity.

### TECHNICAL FIELD

The present invention relates to a contact lens distribution/storage method. The present invention also relates to a contact lens package that can be favorably used with this distribution/storage method.

### BACKGROUND ART

As typical matters for contact lenses, it takes from several months to several years for the distribution and storage period from the time of manufacture by the manufacturing company until actual use by the user. More specifically, in one example of contact lens distribution path, after going through an inventory period at the manufacturing source, contact lenses manufactured by the manufacturing company are delivered to a contact lens sales outlet. Next, these contact lenses are sold to a user after an inventory time at the sales outlet store. After going through an inventory period with the user himself, these contact lenses are finally used (worn) by the user. In addition to the storage period in the manufacturer warehouse or the like after manufacturing, contact lenses in the distribution path are kept under various environmental conditions at each stage such as during transport to the sales outlet, while being in inventory at a store, while being kept by the user himself, and the like.

Meanwhile, contact lenses are medical devices, and are items worn directly on the human body, specifically the user's eyes. Thus, it is necessary to maintain a sterile state over the long period assumed until actual use, and to have a stable storage state which allows prevention of degeneration of the contact lenses or the like.

In light of this, a contact lens package, as discussed in Patent Document 1, is used for contact lens distribution and storage, wherein contact lenses are immersed in packaging solution and stored within a thick hard resin container of a suitable capacity, and hermetically sealed by a sealing sheet. This kind of contact lens package is shipped from the manufacturer in a sterile state through heat sterilization or the like, and at the time of use by the user, the package is unsealed for the first time and the contact lenses are used.

However, with this kind of prior art structure contact lens package, the package was large and bulky, and carrying was troublesome. In particular, with disposable contact lenses for which lenses are replaced in a short period such as daily wear or the like, there was the problem that this was not suitable for carrying around a plurality of contact lenses when on a business trip, traveling or the like.

In response to this kind of need, this applicant proposed a contact lens package with a structure that is compact and is excellent for carrying as noted in Patent Document 2. With, this contact lens package, by sealing only a small volume of packaging solution with a thin sheet structure for the overall package, it is possible to keep the contact lenses while saving space, and it is easy to carry a plurality of contact lenses consolidated together. Also, during contact lens distribution and storage as well, because of the space saving, it is possible to advantageously suppress the storage cost and distribution cost.

Meanwhile, a contact lens package as noted in Patent Document 3 has also been proposed. The contact lens package noted in Patent Document 3 is constituted from a base and a cover, and the contact lens and packaging solution are made to be stored inside a dome shaped hollow formed on the base. T his kind of contact lens package, by having the shape of the hollow be a dome shape that matches the shape of the contact lens, has a volume of contact lens packaging solution required during sealing that is less than 0.75 mL. This makes it possible to save on the manufacturing cost more than with the prior art contact lens packages.

However, with a contact lens package of this form, the packaging solution sealed in the package is a small volume, so the state of the packaging solution changes easily, and it became clear that it is difficult to keep a stable storage state for the contact lenses. In specific terms, due to elution of a polymer base material or its degradation matter from soft contact lenses, carbon dioxide dissolution from outside the contact lens packaging into the packaging solution or the like, it newly became clear that fluctuations in the pH of the packaging solution were caused. If fluctuation of the pH of the packaging solution occurs, it is possible that this would have an effect on the optical properties of the soft contact lenses, that the optical characteristics of the contact lenses would change, and that a problem would occur with vision correction. Furthermore, if the pH fluctuates significantly, when the contact lens is worn and the packaging solution contacts the eye, there is the risk of causing eye irritation. Because of this, it is preferable that the pH be kept constant.
Patent Document 1: JP-A-9-175575
Patent Document 2: JP-A-2004-538220
Patent Document 3: JP-A-2000-23 8840

### SUMMARY OF THE INVENTION

### Problem the Invention Attempts to Solve

With the circumstances described above as the background, the object of the present invention relating to a contact lens distribution/storage method is to provide a contact lens distribution/storage method that saves space and can store contact lenses with stability by using a packaging solution having a large pH buffering capability in a small volume contact lens package. Also, an object of the present invention relating to a contact lens package is to provide a novel contact lens package that can distribute and store contact lenses with stability by using a packaging solution having a large pH buffering capability.

### Means for Solving the Problems

Following are modes of the present invention relating to a contact lens distribution/storage method and of the present invention relating to a contact lens package. The constituent elements used with the modes noted below can be used in any combination possible. Also, it should be understood that the modes and technical features of the present invention are not limited to the items discussed below, but rather they are the items shown in the overall description and the drawings, or items recognized based on the invention concepts that can be understood by a person skilled in the art from the descriptions thereof.

A mode of the present invention relating to the contact lens distribution/storage method provides a contact lens distribution/storage method using a contact lens package in which are contained a packaging solution and a contact lens, being characterized in that: a soft contact lens is selected as the contact lens; a fluid volume of the packaging solution is held within a range of 0.1 to 1.0 mL; and a buffering capability of the packaging solution is arranged to have a buffering capacity of 3 mmol/L or greater.

With this kind of contact lens distribution/storage method according to the present invention, the packaging solution has a large pH buffering capability, so fluctuation of the pH of the packaging solution due to elution of a polymer base material or its degradation matter from soft contact lenses, carbon dioxide dissolving from outside the contact lens packaging into the packaging solution or the like can be suppressed. Thus, even if there is a small amount of packaging solution, it is possible to keep the contact lenses in a stable storage state. As a result, fluctuations in the optical properties of the soft contact lens due to pH fluctuations, or changes in the optical characteristics of the contact lenses accompanying that or the like can be suppressed, and it is possible to prevent adverse effects on vision correction. By keeping the pH changes to 1.0 or less, it is possible to suppress eye irritation when wearing the contact lenses.

With the present invention, the packaging solution means a solution that keeps the contact lenses in a swollen state during the storage time from the packaging of the contact lenses with the contact lens manufacturing process until the post-manufacturing distribution processes and use by the user.

Also, with the present invention, the buffering capacity as an index showing the buffering capability of the packaging solution is defined as follows. Specifically, when adding acid components to the packaging solution, the value measuring how many mmol of acid component is added per I L of the solution until the pH drops by 1.0 from the initial pH value is the buffering capacity (mmol/L).

Also, a mode of the present invention relating to the contact lens package provide a contact lens package that includes a packaging solution and a contact lens, being characterized in that: a soft contact lens is selected as the contact lens; a container area of the contact lens package has a capacity within a range of 0.1 to 1.0 mL excluding a volume of the contact lens; and a solution having a buffering capacity of 3 mmol/L or greater is used as the packaging solution.

With this kind of contact lens package according to the present invention, a packaging solution having a large pH buffering capability is used, so even with a compact contact lens package for which the packaging solution is 1.0 mL or less, it is possible to suppress fluctuation of the pH of the packaging solution during the distribution/storage time, and to keep the contact lenses in a stable storage state.

### BRIEF DESCRIPTION OF THE DRAWINGS

FIG. 1 is a perspective view showing the contact lens package used with an embodiment of the present invention relating to a contact lens distribution/storage method.

FIG. 2 is a cross sectional view of the contact lens package shown in FIG. 1.

FIG. 3 is a cross sectional view of the contact lens package used with another embodiment of the present invention relating to a contact lens distribution/storage method.

FIG. 4 is a graph showing the change in pH of examples of the packaging solution used for the contact lens package shown in FIG. 1 and comparative examples.

FIG. 5 is a graph showing the change in pH of other comparative examples of the packaging solution used for the contact lens package shown in FIG. 1.

FIG. 6 is a graph showing the change in pH of yet other examples of the packaging solution used for the contact lens package shown in FIG. 1.

### KEYS TO SYMBOLS

10: Contact lens package, 12: Contact lens, 14: Packaging solution, 16: Sheet material, 18: Adhesion part, 20: Container area

### BEST MODE FOR CARRYING OUT THE INVENTION

Following, we will describe an embodiment of the present invention to make even more specifically clear the present invention relating to a contact lens distribution/storage method and the present invention relating to a contact lens package.

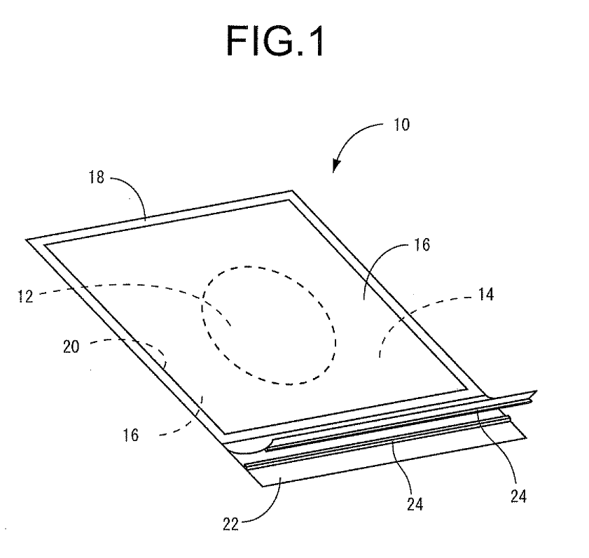

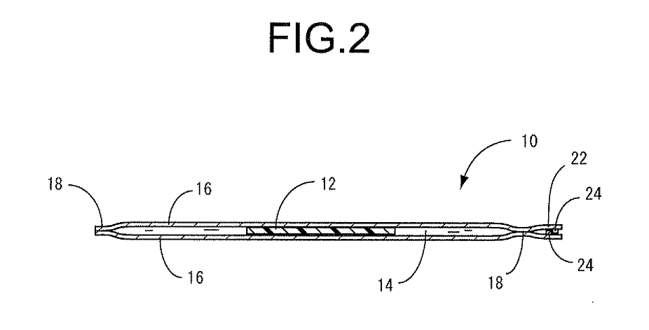

First, in FIG. 1 and FIG. 2, a contact lens package 10 used with an embodiment of the present invention of the contact lens distribution/storage method is shown in model form. A contact lens 12 and a packaging solution 14 are hermetically sealed and contained in this contact lens package 10, and this is used for distribution and storage of the contact lens 12.

In more detail, the contact lens package 10 is constituted with two sheet materials 16 front and back overlapping each other as the sheet layer. Also, as shown in FIG. 1 and FIG. 2, near the four sides of the rectangular sheet material 16, a tightly adhered adhesion part 18 is formed by heat sealing or the like of the front and back sheet materials 16 with each other. Accordingly, a container area 20 for containing the contact lens 12 is formed between the overlapping surfaces of the front and back sheet materials 16 on the inner circumference side of the adhesion part 18.

The raw material for the sheet material 16 used for the contact lens 12 is not particularly restricted as long as it is a material that can have sufficient hermetic sealing properties and the like, but with this embodiment, a laminated film is used for which 12 μm of PET, 20 μM of aluminum laminate, 12 μm of PET, and 35 μm of CPP are laminated to make a film material in that sequence, in order facing from the outside to the inside. The 35 μm of CPP is used for easy peel processing. The carbon dioxide transmission rate of the sheet material 16 with this embodiment is 1.0 cm³/(m²·hr·atm) or less.

Then, the adhesion part 18 of the sheet material 16 of this embodiment forms an overall rectangular circumference shape by mutually adhering the two sheet materials 16 front and back. The container area 20 of the contact lens 12 is defined between the overlapping surfaces of the sheet materials 16 on the inner circumference side of this adhesion part 18. The adhesion part 18 is formed by mutually adhering the sheet materials 16 by a known adhesion method such as heat sealing or the like. Then, when unsealing the contact lens package 10, the contact lens 12 is made to be taken out from the container area 20 by mutually peeling this adhesion part 18. T he adhesion part 18 is made so that mutual peeling by the user of the sheet materials 16 is easy during unsealing of the contact lens package 10 by undergoing easy peel processing.

Meanwhile, an unsealing start part 22 is formed on the outer circumference side of one side of the adhesion part 18 made in a rectangular circumference shape. This unsealing start part 22 is formed so as to extend out from the outer circumference side of the adhesion part 18, and is left in a state with the two sheet materials 16 not adhered together. Therefore, when unsealing the contact lens package 10, the user inserts a finger between the mutually overlapped layers of this unsealing start part 22, and each end part of the two sheet materials 16 are made to be easily grasped.

Furthermore, projections 24 are respectively formed on each sheet material 16 on the overlapping surface side of this unsealing start part 22. With this arrangement, when the user grips one sheet each of the sheet materials 16 when unsealing the contact lens package 10, by the projections 24 working as grips, grasping the respective sheet materials 16 is easier.

Then, by peeling apart the two sheet materials 16 in the separating direction in sequence from the unsealing start part 22 for which this projection 24 is formed, the entire surface of the contact lens package 10 is unsealed, and the contact lens 12 contained in the container area 20 is taken out. This container area 20 is formed defined between the overlapping surfaces of the two sheet materials 16 front and back on the inner circumference side of the adhesion part 18. The packaging solution 14 and the contact lens 12 are contained in this container area 20.

Here, as the contact lens 12 of this embodiment, soft contact lenses are used. This embodiment of the contact lens distribution/storage method is particularly favorably used with distribution and storage of disposable type soft contact lenses used to be disposed of in a short period such as one day wear or two week wear or the like.

The contact lens 12 forming material used with this embodiment is not particularly restricted as long as it is a forming material that can generally be used as a contact lens forming material, and resin materials consisting of various types of polymerizable monomers can be used, but this embodiment can be particularly favorably used with contact lenses consisting of a material that produces an acid component. As examples of this kind of contact lens material that produces an acid component, we can list, components including an acryl group or methacryl group, specifically, we can list methacrylic acid, methyl methacrylate, ethyl methacrylate, propyl methacrylate, isopropyl methacrylate, butyl methacrylate, hydroxy methyl methacrylate, 2-hydroxyethyl methacrylate, 2-hydroxypropyl methacrylate, glycerol methacrylate, ethylene glycol methacrylate, acrylic acid, methyl acrylate, ethyl acrylate, propyl acrylate, isopropyl acrylate, butyl acrylate, dimethyl acrylamide and the like. As the material of the contact lenses 12, these materials can be used alone, or a plurality of materials can be used in combination. It is also additionally possible to suitably blend any additives.

Also, the packaging solution 14 is made to be contained together with the contact lens 12 in the container area 20. The container area 20 is constituted by hermetically sealing and defining flexible sheet materials 16 with the adhesion part 18, so the container capacity is variable according to the fluid volume of the packaging solution 14. Specifically, 0.1 to 1.0 mL of the packaging solution should be able to be contained together with the contact lens 12, excluding the volume of the contact lens, in the container area 20 of the contact lens package 10 of this embodiment. Incidentally, with this embodiment, approximately 0.1 to 0.3 mL of the packaging solution 14 is contained in a hermetically sealed state, and the container capacity is about 0.1 to 0.5 mL.

Then, on the interior of this kind of container area 20, the contact lens 12 is made to be contained while immersed in the packaging solution 14 in a state compressionally deformed in the front and back direction (the direction for which the contact lens 12 is convex in a mountain shape). The contact lens 12 can easily be compressionally deformed because it is formed using a soft contact lens raw material. Also, after unsealing, due to the elasticity of the contact lens 12 itself, it is easily restored to the specified convex shape.

Then, as the packaging solution 14 of this embodiment, a solution having buffering capability of buffering capacity 3 mmol/L or greater is used. With the present invention, the buffering capacity value as an index showing buffering capability is defined as follows. Specifically, when adding acid components to the packaging solution 14, the value measuring how many mmol of acid component is added per 1 L of the solution until the pH drops by 1.0 from the initial pH value is the buffering capacity (mmol/L).

In specific terms, with this embodiment, the buffering capacity of the solution is measured as follows. First, the initial pH value of the buffering solution used as the packaging solution 14 is measured using a pH meter. At this time, if necessary, so that the pH value is in a range of pH 5.5 to 8.0 which is preferable for use as the packaging solution 14, and more preferably a range of pH 6.0 to 7,5, the pH is adjusted using a suitable titration solution such as hydrochloric acid or the like. Then, with this embodiment, using a hydrochloric acid solution as the titration solution containing an acid component, this is dripped in the buffering solution used as the measurement subject, the pH decrease status is observed, and the cumulative drop volume of hydrochloric acid (mmol) when the pH of the solution decreased by 1.0 from the initial value was checked. As a result, when the pH decreased by 1.0 from the initial value, the buffering capacity value (mmol/L) was determined by how many mmol the hydrochloric acid drop volume per 1 mL of buffering solution was.

More specifically, with this embodiment, using a concentration 0.5 mol/L hydrochloric acid solution, the buffering capacity was measured by dripping 60 μL at a time of the hydrochloric acid solution in 30 mL of the buffering solution which is the measurement subject. Specifically, with this embodiment, when 1 mmol at a time of hydrochloric acid (specifically, H⁺ and Cl⁻) was dripped in 1 L of the buffering solution, the buffering capacity (mmol/L) of that solution was determined by the cumulative drop volume of hydrochloric acid when the pH value had decreased by 1.0. For example, when the initial pH of the buffering solution is 7.0, and the pH becomes 6.0 with dripping of hydrochloric acid, if the cumulative drop volume of hydrochloric acid was 3 mmol per 1 L of buffering solution, the buffering capacity of that buffering solution is 3 mmol/L.

Then, with this embodiment, the buffering capability of the packaging solution 14 is adjusted so that the buffering capacity found by the test described above becomes 3 mmol/L or greater. Specifically, with this embodiment, the packaging solution 14 contains a buffering agent, and this buffering agent is constituted from sodium chloride, disodium hydrogen phosphate, and sodium dihydrogen phosphate. Also, the blending ratio is, for 100 weight parts water as the solvent, 0.6 to 1.0 weight parts of sodium chloride, 0.05 to 0.3 weight parts disodium hydrogen phosphate, and 0.005 to 0.03 weight parts of sodium dihydrogen phosphate. More specifically, the disodium hydrogen phosphate as a buffering agent is prepared using a disodium hydrogen phosphate•12-hydrate, and the blending ratio noted above is converted by subtracting the water weight from the weight of the disodium hydrogen phosphate•12-hydrate. Similarly, the ratio of the sodium dihydrogen phosphate is calculated by subtracting the weight of the water from the weight of the sodium dihydrogen phosphate•2-hydrate that is actually used. Then, by adding these buffering agents, the packaging solution 14 is a phosphate buffering solution of buffering capacity 3 to 9 mmol/L.

As the buffering agent added to give buffering capability to the packaging solution 14 in this way, as long as it is in a range for which the buffering capacity stipulated by the present invention can be exhibited, and it does not affect the eye of the user when the contact lens 12 is worn, any specific substance or blending ratio can be selected, but it is preferable to use the substances listed below either alone or with a plurality combined. Specifically, first, as phosphate compounds that act as a phosphate buffering agent, we can list phosphoric acid, sodium dihydrogen phosphate, sodium dihydrogen phosphate•2-hydrate, disodium hydrogen phosphate, disodium hydrogen phosphate•12-hydrate, trisodium phosphate, trisodium phosphate•12-hydrate, tetrasodium pyrophosphate, tetrasodium pyrophosphate•10-hydrate, disodium dihydrogen pyrophosphate, dipotassium phosphate•3-hydrate, potassium dihydrogen phosphate, dipotassium phosphate, tripotassium phosphate, potassium pyrophosphate, calcium phosphate•hydrate, dicalcium phosphate•2-hydrate, and the like. As carbonate compounds that act as a carbonate buffering solution, we can list sodium hydrogen carbonate, sodium carbonate, sodium carbonate•1-hydrate, calcium hydrogen carbonate, calcium carbonate, potassium carbonate, potassium hydrogen carbonate and the like. Furthermore, as borate compounds that act as a borate buffering solution, we can list boric acid, sodium borate, potassium borate, sodium tetraborate•10-hydrate and the like. Furthermore, as citrate compounds that act as a citric acid buffering solution, we can list citric acid, sodium citrate•2-hydrate, potassium citrate•1-hydrate and the like. As acetate compounds that act as an acetic acid buffering solution, we can list acetic acid, sodium acetate, sodium acetate•3-hydrate, potassium acetate and the like. Then, as other substances that can be used as buffering agents, we can list chlorides such as hydrochloric acid, sodium chloride, potassium chloride, magnesium chloride, calcium chloride and the like, hydroxides such as sodium hydroxide, potassium hydroxide, calcium hydroxide and the like, or also tris substances or the like such as tris hydroxymethyl aminomethane, tris hydroxymethyl aminomethane hydrochloride or the like.

Then, as the buffering agent of the packaging solution 14 with this embodiment, of the substances noted above, in particular, substances selected from sodium dihydrogen phosphate, disodium hydrogen phosphate, boric acid, borax, and sodium hydrogen carbonate are preferably used either alone or with a plurality among these combined with each other. More preferably, the buffering agent of the packaging solution 14 is constituted including sodium chloride, sodium dihydrogen phosphate, and disodium hydrogen phosphate.

In this way, with this embodiment, by the buffering capacity for which a buffering agent is blended in the packaging solution 14 being made to be 3 mmol/L or greater, the packaging solution 14 has sufficient buffering capability for the acid component. With this arrangement, during the distribution and storage period of the contact lens 12 it is possible to advantageously suppress or prevent a drop in the pH of the packaging solution 14 due to elution of the acid component from methacrylic acid or 2-hydroxyethyl methacrylate or the like which is the polymer base material of the contact lens 12.

The packaging solution 14 is preferably adjusted to a suitable osmotic pressure by appropriately adding a substance such as sodium chloride or the like. Accordingly, it is possible to suppress an effect on the eye when the user uses the contact lenses 12, and also to store the contact lenses 12 in a more suitable state.

With this embodiment, the fluid volume of the packaging solution 14 contained in the container area 20 of the contact lens package 10 is 0.1 to 1 mL. More preferably, the fluid volume is 0.1 to 0.5 mL. Specifically, with the prior art contact lens packages, the pH decreased significantly during the distribution and storage period when the fluid volume of the packaging solution is made low, but with this embodiment, by having a buffering agent included in the packaging solution 14 and having the buffering capacity be 3 mmol/L or greater, even with a small fluid volume, it is possible to prevent a decrease in the pH of the packaging solution 14 due to elution of an acidic polymer base material or the like, and it is possible to keep the pH value roughly constant for a long period. So as to be able to contain the packaging solution 14 and the contact lens 12 of this volume, the container capacity of the contact lens package 10 is preferably 0.1 to 1.0 mL, more preferably 0.1 to 0.5 mL, and most preferably 0.15 to 0.3 mL.

Furthermore, the pH of the packaging solution 14 is adjusted to within a range of 5.5 to 8.0, and more preferably within a range of pH 6.0 to 7.5. Accordingly, during distribution and storage of the contact lenses 12, it is possible to keep the contact lenses 12 in a suitable state. Also, there is a reduction in effects such as irritation or the like to the eyes during use by the user. In addition, the packaging solution 14 is preferably kept to a pH decrease of 1.0 or less even during the distribution and storage period after sealing of the contact lens package 10 during manufacturing.

Then, with the distribution and storage method of the contact lenses 12 using this kind of contact lens package 10 of this embodiment, at the manufacturer, after hermetically sealing the contact lens package 10 in a state with the contact lens 12 and the packaging solution 14 being sealed between the overlapping surfaces of the two sheet materials 16 for completion, sterilization processing is done using an autoclave or the like and shipping is done. Here, by having the packaging solution 14 inside the contact lens package 10 include a buffering agent and having high buffering capacity, despite only a small volume of the packaging solution 14 of 0.1 to 1.0 mL being sealed, even during the distribution and storage period after shipping, the pH of the packaging solution 14 is kept roughly constant. Accordingly, during the time from when the contact lens 12 is packaged until it is worn by the user, it is possible to store the contact lens 12 in an ideal state.

In specific terms, for example by blending 0.66 weight parts sodium chloride, and 0.26 weight part disodium hydrogen phosphate and 0.03 weight parts sodium dihydrogen phosphate as buffering agents in 100 weight parts water as the packaging solution 14, a solution for which the buffering capacity for pH 7.0 is 9 mmol/L is prepared, 0.1 mL of this packaging solution 14 and the contact lens 12 are sealed in the contact lens package 10 described above, and when unsealed after storing for 21 days at 80° C., the pH of the packaging solution 14 at the time of unsealing is 6.6, which is a decrease of only 0.4 from the pH value when storage started. In this way, if this embodiment is followed, it is possible to suppress the decrease range of the pH of the packaging solution 14 during long storage periods of the contact lens 12 to 1.0 or less,

Also, if this embodiment is followed, it is possible to make the contact lens package 10 have a very small volume, so as noted in JP-A-9-175575, compared to the distribution/storage method using a large volume contact lens package of the prior art structure, it is possible to decrease the sealing volume of the packaging solution 14, and in addition, this is extremely space saving and light weight, so it is possible to distribute and store the contact lenses 12 at low cost. Since it is possible to save space occupied during storage, it is easy to stock and store a large number of inventory of various types of contact lenses 12 according to optical characteristics at the store or manufacturer. After purchase by the user, carrying is easy when it is necessary to carry a large number of contact lenses 12 such as for travel or the like.

Furthermore, by selecting a substance that has a small effect on the human body and contact lens raw material such as phosphoric acid or the like as the buffering agent, and by keeping the pH of the packaging solution 14 constant, we can anticipate that eye irritation will not occur easily with wearing, and that fluctuations in standards of the soft contact lenses will not occur.

Above, we described in detail an embodiment of the present invention relating to the contact lens distribution/storage method, and the present invention relating to the contact lens storage package, but these are nothing more than examples, and neither of the present inventions is interpreted restrictively in any way by the specific descriptions of the embodiments.

For example, with each of the embodiments noted above, as the contact lens package 10, a sheet shaped contact lens package 10 consisting of the sheet material 16 is used, but the contact lens package used with the present invention relating to the contact lens distribution/storage method is not limited to this, and any item can be used as long as the contained packaging solution 14 volume is 0.1 to 1.0 mL. In this case, it is preferable that the contact lens 12 be in a suitably immersed state within the small volume packaging solution 14. The contact lens 12 is not limited to being distributed and stored in a compressed state, and it goes without saying that items that are distributed and stored in a non-compressed state are included in the present invention. Furthermore, the contact lens package 10 does not have to have both the front and back surfaces formed by flexible sheet material 16, but for example can also have one of the surfaces be a hard, plate shaped sheet.

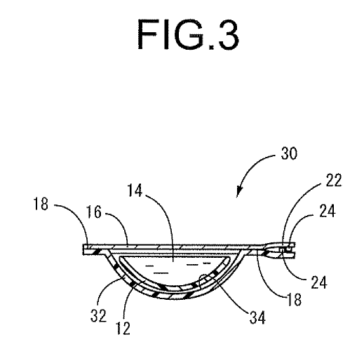

As shown in FIG. 3, the same as with the prior art contact lens package, it is also possible to use a contact lens package 30 consisting of a hard synthetic resin raw material. With the description below, regarding members and parts constituted in the same way as the embodiments described above, the same code numbers are given as in the embodiments described above in the drawings, and a detailed description of those is omitted. The contact lens package 30 shown in FIG. 3 is constituted by hermetically sealing the package main unit 32 consisting of a synthetic resin such as polypropylene or the like using the sheet material 16. At the center part of the package main unit 32, a roughly hemispherical concave container part 34 is formed, and inside this container part 34, the contact lens 12 and a small volume of the packaging solution 14 are contained. If this kind of contact lens package 30 is used, by the shape of the container part 34 being a roughly semicircular shape to match the outline of the contact lens 12, it is possible to sufficiently immerse the contact lens 12 with only a small volume of packaging solution 14 compared to the prior art contact lens package, and to reduce the manufacturing cost and the like. Then, even when sealing a small volume of packaging solution 14 using this kind of formed resin contact lens package 30, the same as with the embodiments described above, by having the buffering capability of the packaging solution 14 be a buffering capacity of 3 mmol/L or greater, it is possible to sufficiently suppress a decrease in pH due to elution of the soft contact lens raw material or the like.

In addition, though not individually listed as examples, the present invention can be implemented in modes with various modifications, revisions, amendments and the like added based on the knowledge of a person skilled in the art, and it goes without saying that any such embodiment is included within the scope of the present as long as it does not stray from the gist of the present invention.

### EXAMPLES

Following, several examples of the present invention relating to the contact lens distribution/storage method and the present invention relating to the contact lens package are shown, and the present inventions are made more specifically clear, but it goes without saying that the present inventions are not restricted in any way by the descriptions of such examples. It should be understood that in addition to the following examples, as long as they do not stray from the gist of the present inventions, various modifications, revisions, amendments and the like can be added in addition to the specific descriptions noted above based on the knowledge of a person skilled in the art.

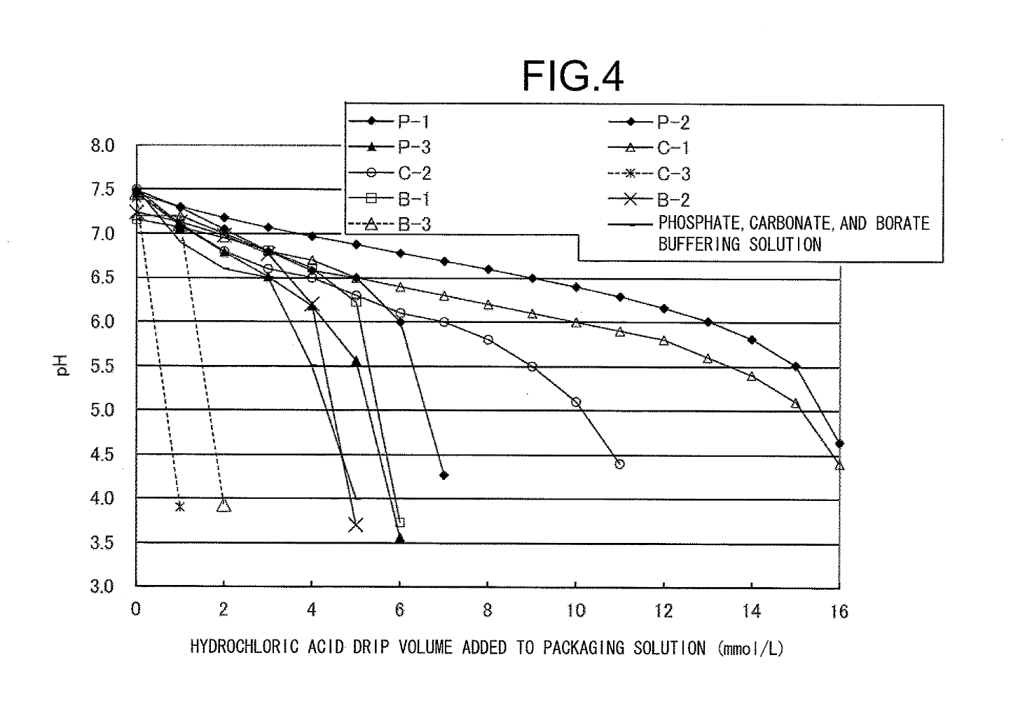

First, as examples and comparative examples of the solution that can be used as the packaging solution 14 of the contact lens package 10, as shown in Table 1 and FIG. 4 below, the concentrations were variously changed and phosphate buffering solutions (P-1, P-2, P-3), carbonate buffering solutions (C-1, C-2, C-3), borate buffering solutions (B-1, B-2, B-3), and a phosphate, borate, and carbonate buffering solution were respectively prepared, and the buffering capacity of each solution was measured.

TABLE 1

| | | | | | | | | | | | Phosphate, |
|---|---|---|---|---|---|---|---|---|---|---|---|
| | | | | | | | | | | | carbonate, |
| | | | | | Carbonate buffering solution | | | Borate buffering solution | | | and borate |
| | | Phosphate buffering solution | | | | | C-3 | | | B-3 | buffering |
| | | P-1 | P-2 | P-3 | C-1 | C-2 | Comp. | B-1 | B-2 | Comp. | solution |
| | | Ex.1 | Ex.2 | Ex.3 | Ex.4 | Ex.5 | Ex. 1 | Ex.6 | Ex.7 | Ex. 2 | Ex.8 |
| Buffering | NaCl | 0.6570 | 0.7607 | 0.7952 | 0.6421 | 0.6704 | 0.6000 | 0.1832 | 0.2734 | 0.5631 | 0.5844 |
| agent | Na₂HPO₄ | 0.2378 | 0.1189 | 0.0793 | — | — | — | — | — | — | — |
| blending | NaH₂PO₄ | 0.0406 | 0.0203 | 0.0135 | — | — | — | — | — | — | 0.0120 |
| volume | NaHCO₃ | — | — | — | 0.1500 | 0.1000 | 0.0067 | — | — | — | 0.0420 |
| (weight | H₃BO₄ | — | — | — | — | — | — | 1.1367 | 0.9473 | 0.3789 | 0.0619 |
| parts) | Borax | — | — | — | — | — | — | 0.0202 | 0.0168 | 0.0067 | — |

| | | | | | | | | | | |
|---|---|---|---|---|---|---|---|---|---|---|
| pH before titration | 7.5 | 7.5 | 7.5 | 7.2 | 7.5 | 7.4 | 7.2 | 7.2 | 7.5 | 7.5 |
| pH after titration | 6.5 | 6.5 | 6.5 | 6.2 | 6.5 | (3.9) | 6.2 | 6.2 | (3.9) | 6.5 |
| Hydrochloric acid drip | 9 | 5 | 3 | 8 | 4 | 0 | 5 | 4 | 1 | 3 |
| volume (μmol/mL) | | | | | | | | | | |
| (= buffering capacity | | | | | | | | | | |
| (nmol/L)) | | | | | | | | | | |

Specifically, with the phosphate buffering solutions P-1, P-2, and P-3 shown as examples 1 through 3 in Table 1, sodium chloride, disodium hydrogen phosphate, and sodium dihydrogen phosphate are included as buffering agents, and for each component, for 100 weight parts of water, 0.65 to 0.80 weight parts of sodium chloride, 0.08 to 0.24 weight parts of disodium hydrogen phosphate, and 0.01 to 0.04 weight parts of sodium dihydrogen phosphate are included in the amounts as noted respectively in Table 1. More specifically, the disodium hydrogen phosphate is prepared using disodium hydrogen phosphate•12-hydrate, and the value of the blend ratio is converted by subtracting the water weight from the weight of the disodium hydrogen phosphate•12-hydrate. Similarly, the ratio of the sodium dihydrogen phosphate is converted by subtracting the water weight from the weight of the actually used sodium dihydrogen phosphate•2-hydrate. Similarly, the carbonate buffering solutions C-1 and C-2 shown as examples 4 and 5 include sodium chloride and sodium hydrogen carbonate as buffering agents, and for 100 weight parts of water, 0.65 to 0.80 weight parts of sodium chloride and 0.1 to 0.2 weight parts of sodium hydrogen carbonate are included in the amounts as noted respectively in Table 1. The borate buffering solutions B-1 and B-2 shown as examples 6 and 7 include sodium chloride, boric acid, and borax as buffering agents, and for 100 weight parts of water, 0.1 to 0.3 weight parts of sodium chloride, 0.8 to 1.2 weight parts of boric acid, and 0.01 to 0.03 weight parts of borax are included in the ratios respectively shown in

Table 1. Furthermore, the phosphate, borate, and carbonate buffering solution shown as example 8 includes as buffering agents sodium chloride, sodium dihydrogen phosphate, sodium hydrogen carbonate, and boric acid, and for 100 weight parts of water, 0.58 weight parts of sodium chloride, 0.01 weight parts of sodium dihydrogen phosphate, 0.04 weight parts of disodium hydrogen phosphate, and 0.062 weight parts of boric acid are included in the ratios respectively shown in Table 1. For these reagents, other than borax, all the items used were made by Nacalai Tesque Inc., and the borax used was made by Tomiyama Pure Chemical Industries, Ltd.

The carbonate buffering solutions C-1, C-2, and C-3 shown as examples 4 and 5 and comparative example 1 have the pH adjusted in advance using 0.1 M hydrochloric acid solution, and were used as reagents after setting to the pH value before titration shown in Table 1. The hydrochloric acid used for titration is a special grade hydrochloric acid reagent made by Nacalai Tesque Inc.

Then, using 30 mL each of the solutions shown in Table 1, the change in pH was measured with dripping of 60 μL each of the hydrochloric acid solution of 0.5 mol/L in each solution, and the buffering capacity was found, To say this another way, with this test, 1 μmol each of hydrochloric acid per 1 mL of buffering solution (specifically, 1 mmol per 1L) was added and the pH was measured to find the buffering capacity. The measurement results of the pH of each solution of the P-1 to 3, C-1 to 3, B-1 to 3, and phosphate, borate, and carbonate buffering solution at this time are as shown in the graph in FIG. 4.

Further, the pH at the start of titration for each solution is as shown in Table 1. Then, the pH value when the value of the pH of each solution has decreased by 1.0 from the value before this titration is shown as the pH after titration in Table 1, and the cumulative volume of hydrochloric acid added until the value of pH decreases by 1.0 is shown as the hydrochloric acid drip volume (μmol/mL). This value specifically becomes the buffering capacity (mmol/L).

As shown in FIG. 4 and Table 1, with examples 1 through 8, when 9 to 3 μmol/mL of hydrochloric acid was respectively added to 1 mL of each solution, the pH value decreased by 1.0. Specifically, the buffering capacity for each example was 9 to 3 mmol/L. With comparative example 1, the pH decreased from 7.4 to 3.9 at the point that 1 μmol/mL of hydrochloric acid was added per 1 mL of buffering solution, so it was not possible to accurately measure the buffering capacity, and the buffering capacity was 0 mmol/L. Also, with comparative example 2, the pH was 7.1 at the point that 1 μmol of hydrochloric acid was added to 1 mL of buffering solution, and the pH was 3.9 at the point that 2 μmol was added per 1 mL, so the buffering capacity was 1 mmol/L.

In this way, the solutions of examples 1 through 8 all have a large buffering capability with buffering capacity of 9 to 3 mmol/L, and even when 9 to 3 mmol of hydrochloric acid is added respectively to 1L, the decrease in pH is 1.0 or less. Meanwhile, the solutions shown in comparative examples 1 and 2 have a buffering capacity of 0 to 1 mmol/L, and the pH decrease was 1.0 or greater at the point that 1 or 2 mmol of hydrochloric acid was added per 1L. With this, if the solutions shown in examples 1 through 8 are used as the packaging solution 14, compared to the solutions of comparative examples 1 and 2, even when a large volume of an acidic substance is added, we can see that it is possible to more effectively suppress the decrease in pH.

Next, each solution of the examples and the comparative examples used for the tests above were sealed in the contact lens package 10, and testing was performed using this as the packaging solution 14.

As the contact lens package of this test, the same kind of item as the contact lens package 10 noted as an embodiment of the present invention described above was used. Also, the carbon dioxide transmission rate of the sheet material 16 used for the contact lens package used with this test was 1.0 cm³/(m²•hr•atm) or less.

Here, first only the packaging solution 14 is sealed without sealing the contact lens 12 in the concerned contact lens package 10, and testing was performed to check the change in pH.

Specifically, with this test, the solution of the phosphate buffering solution P-1 for which the buffering capacity was measured as the example 1 and of the phosphate buffering solution P-3 for which the buffering capacity was measured as example 3 are used as the packaging solution 14, and a plurality of items were prepared for which 0.1 mL each of each packaging solution 14 was sealed in the contact lens package 10. These contact lens packages 10 were stored at 80° C., and the respective contact lens packages 10 were unsealed at before storage start, 2 days after storage start, 7 days after, 14 days after, and 21 days after, and the pH of the packaging solution was measured. The pH measurement results are as shown in Table 2 below.

TABLE 2

| | | | | Change in pH | | | | |
|---|---|---|---|---|---|---|---|---|
| | Packaging Solution | | | | 2 days | 7 days | 14 days | 21 days |
| | | Buffering | Fluid | Before | after | after | after | after |
| Test | Solution | capacity | volume | storage | storage | storage | storage | storage |
| reagent | type | (mmol/L) | (mL) | start | start | start | start | start |
| Reference | Phosphate | 9 | 0.1 | 7.3 | 7.3 | 7.2 | 7.1 | 7.1 |
| example 1 | buffering | | | | | | | |
| (without | solution | | | | | | | |
| lens) | P-1 | | | | | | | |
| Reference | Phosphate | 3 | 0.1 | 7.2 | 7.2 | 7.0 | 6.9 | 6.9 |
| example 2 | buffering | | | | | | | |
| (without | solution | | | | | | | |
| lens) | P-3 | | | | | | | |

As is clear from the results shown in Table 2, for both reference example 1 and reference example 2, even 21 days after the test start, we can see that there is almost no change in the pH value. In specific terms, we can see that with reference example I for which the buffering capacity is 9 mmol/L, the pH of the solution only decreased by 0.2 in 21 days, and with reference example 2 for which the buffering capacity is 3 mmol/L, the pH of the solution only decreased by 0.3 in 21 days.

Next, the contact lens 12 and the packaging solution 14 were actually sealed inside the contact lens package 10, and a test was performed to check the change in pH.

First, as the contact lens 12 used for this test, a soft contact lens for which the main component is 2-hydroxyethyl methacrylate was prepared. As the contact lens package of examples 9 to 14, the same as with the previous test, a contact lens package 10 consisting of the sheet material 16 was used. Meanwhile, for reference examples 3, 4, and 5, because of volume issues, a glass bottle was used as the storage container. Furthermore, as the packaging solution 14, as shown in Table 3 below, for the phosphate buffering solution P-1 used with the above tests for examples 9 and 10 and reference example 3, the phosphate buffering solution P-2 used for examples 11 and 12 and reference example 4, phosphate buffering solution P-3 used for examples 13 and 14 and reference example 5, and the carbonate buffering solution C-3 used for comparative examples 3 to 5, respective items of 0.1 mL, 0.3 mL, and 1.5 mL were prepared and used. Then, the contact lens packages in which these contact lenses and packaging solutions were sealed were stored at 80° C., the contact lens packages were respectively unsealed at before storage start, 2 days after start of storage, 7 days after, 14 days after, and 21 days after, and the pH of the packaging solution was measured. The results of the pH measurement are as shown in Table 3 below. This storage test is an accelerated storage test with a storage temperature of 80° C., and with reference to ISO 11987-1997, the storage results for 21 days at 80° C. can be estimated to be roughly the same as the storage results for 950 days at room temperature (25° C.).

TABLE 3

| | | | | Change in pH | | | | |
|---|---|---|---|---|---|---|---|---|
| | Packaging solution | | | | 2 days | 7 days | 14 days | 21 days |
| | | Buffering | Fluid | Before | after | after | after | after |
| | Solution | capacity | volume | storage | storage | storage | storage | storage |
| | composition | (mmol/L) | (mL) | start | start | start | start | start |
| Ex. 9 | Phosphate | 9 | 0.1 | 7.0 | 7.0 | 6.8 | 6.7 | 6.6 |
| | buffering | | | | | | | |
| | solution P-1 | | | | | | | |
| Ex. 10 | Phosphate | 9 | 0.3 | 7.2 | 7.2 | 7.1 | 7.0 | 6.9 |
| | buffering | | | | | | | |
| | solution P-1 | | | | | | | |
| Ref. | Phosphate | 9 | 1.5 | 7.3 | 7.3 | 7.2 | 7.2 | 7.2 |
| ex. 3 | buffering | | | | | | | |
| | solution P-1 | | | | | | | |
| Ex. 11 | Phosphate | 5 | 0.1 | 6.9 | 6.6 | 6.5 | 6.3 | 6.1 |
| | buffering | | | | | | | |
| | solution P-2 | | | | | | | |
| Ex. 12 | Phosphate | 5 | 0.3 | 6.9 | 6.9 | 6.9 | 6.9 | 6.4 |
| | buffering | | | | | | | |
| | solution P-2 | | | | | | | |
| Ref. | Phosphate | 5 | 1.5 | 7.1 | 7.1 | 7.1 | 7.1 | 7.1 |
| ex. 4 | buffering | | | | | | | |
| | solution P-2 | | | | | | | |
| Ex. 13 | Phosphate | 3 | 0.1 | 6.9 | 6.7 | 6.4 | 6.1 | 6.0 |
| | buffering | | | | | | | |
| | solution P-3 | | | | | | | |
| Ex. 14 | Phosphate | 3 | 0.3 | 7.0 | 7.0 | 6.7 | 6.6 | 6.3 |
| | buffering | | | | | | | |
| | solution P-3 | | | | | | | |
| Ref. | Phosphate | 3 | 1.5 | 7.1 | 7.2 | 7.1 | 7.1 | 7.0 |
| ex. 5 | buffering | | | | | | | |
| | solution P-3 | | | | | | | |
| Comp. | Carbonate | 0 | 0.1 | 6.6 | 6.0 | 5.5 | 4.8 | 4.3 |
| ex. 3 | buffering | | | | | | | |
| | solution | | | | | | | |
| | C-3 | | | | | | | |
| Comp. | Carbonate | 0 | 0.3 | 6.8 | 6.4 | 5.7 | 5.3 | 5.0 |
| ex. 4 | buffering | | | | | | | |
| | solution | | | | | | | |
| | C-3 | | | | | | | |
| Comp. | Carbonate | 0 | 1.5 | 7.0 | 7.0 | 6.9 | 6.5 | 6.4 |
| ex. 5 | buffering | | | | | | | |
| | solution | | | | | | | |
| | C-3 | | | | | | | |

As is clear from the results shown in Table 3, when using a solution indicating a high buffering capability for which the buffering capacity is 3 to 9 mmol/L as the packaging solution 14, even if the fluid volume is a small amount of 0.1 mL or 0.3 mL, we can see that the pH almost doesn't decrease at all. Specifically, even after 21 days, the decrease in pH from the pH value before testing was 1.0 or less. Meanwhile, when a solution for which the buffering capacity is 0 mmol/L is used as the packaging solution 14, the pH decreases significantly as time elapses except cases when the fluid volume is high.

Thus, if this embodiment is followed, by using a solution for which the buffering capacity is 3 mmol/L or greater as the packaging solution 14, even when sealing only a very small amount of the packaging solution 14 together with the contact lens 12 in the contact lens package 10, it is possible to prevent a decrease in pH over a long term, and we can see that it is possible to distribute and store the contact lenses 12 in a favorable state.

Next, we will show the results when the contact lens 12 and the packaging solution 14 were sealed within contact lens package 10, this was stored over a long time of several months or more, and stability testing to check the changes in pH was performed.

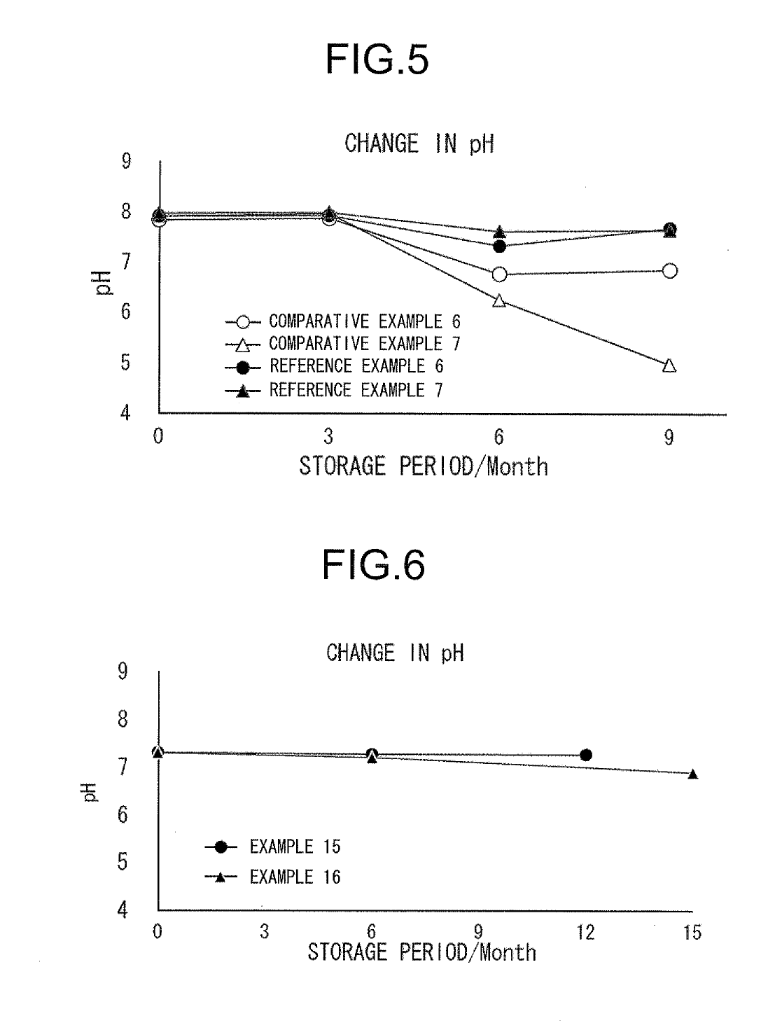

First, the results of using the solution shown as the comparative example 1 (carbonate buffering solution C-3) with the test above are shown in FIG. 5 and Table 4 as the comparative example and reference example. The ratio of each substance of the carbonate buffering solution C-3 is as shown in Table 1 noted above. Specifically, the carbonate buffering solution C-3 includes as buffering agents sodium chloride and sodium hydrogen carbonate, and the blending ratio of these is 0.6 weight parts of sodium chloride and 0.0067 weight parts of sodium hydrogen carbonate for 100 weight parts of water, and the buffering capacity is 0 mmol/L.

Then, together with this packaging solution 14, the same as with the test described above, soft contact lenses 12 with a main component of 2-hydroxyethyl methacrylate were prepared, these were sealed in the contact lens package 10, and storage testing was performed. As shown in Table 4 below, comparative example 6 and comparative example 7 had a fluid volume of 0.15 mL, and reference example 6 and reference example 7 had a fluid volume of 2.6 mL. Because the fluid volume is high for reference examples 6 and 7, instead of the contact lens package 10 consisting of the sheet material 16, a conventional type contact lens package consisting of a package main unit made of polypropylene and an aluminum sheet are used. The changes in pH when these comparative examples and reference examples are stored for 9 months under conditions of temperature 25° C. and 45° C. are shown in Table 4 below. Also, these results are shown in FIG. 5 as a graph. T his storage test was done according to ISO 11987-1997, and the storage results at 45° C. can be estimated as roughly equal to storage results of 4 times the period at room temperature (25° C.).

TABLE 4

| | Storage conditions | | | | | |
|---|---|---|---|---|---|---|
| | Fluid | Temper- | pH | | | |
| | volume | ature | Initial | After 3 | After 6 | After 9 |
| | (mL) | (° C.) | value | months | months | months |
| Comp. | 0.15 | 25 | 7.83 | 7.87 | 6.77 | 6.86 |
| ex. 6 | | | | | | |
| Comp. | 0.15 | 45 | 7.91 | 7.97 | 6.25 | 4.98 |
| ex. 7 | | | | | | |
| Ref. ex. 6 | 2.6 | 25 | 7.91 | 7.93 | 7.33 | 7.69 |
| Ref. ex. 7 | 2.6 | 45 | 7.97 | 7.99 | 7.62 | 7.65 |

As is apparent from the results shown in Table 4 and FIG. 5, with reference examples 6 and 7 for which the fluid volume is 2.6 mL, in comparison to the fact that even with storage for 9 months, the pH decrease range stops at approximately 0.3, with the comparative examples 6 and 7 for which the fluid volume is 0.15 mL, at the point of 6 months from the storage start, the pH decreases by 1.0 or more. In this way, when a solution with buffering capacity of roughly 0 mmol/L (carbonate buffering solution C-3) which does not have sufficient buffering capability is selected as the packaging solution 14, when the fluid volume sealed in the contact lens package 10 is sufficiently large, the pH decrease range is 1.0 or less, but when the fluid volume of the packaging solution 14 is less than 1.0 mL, as the storage period becomes longer, we can see that the decrease in pH is 1.0 or greater.

Next, the results of using the solution shown by the example 1 (phosphate buffering solution P-1) with the test above as the packaging solution 14, sealing this in the contact lens package 10, and performing long term storage testing are shown as examples.

The ratio of each substance of the phosphate buffering solution P-1 used with this test is as shown in Table 1 above. Specifically, the phosphate buffering solution P-1 includes as buffering agents sodium chloride, disodium hydrogen phosphate, and sodium dihydrogen phosphate. Also, the ratio of each substance is 0.66 weight parts of sodium chloride, 0.24 weight parts of disodium hydrogen phosphate, and 0.04 weight parts of sodium dihydrogen phosphate for 100 weight parts of water, and the buffering capacity is 9 mmol/L. The disodium hydrogen phosphate and the sodium dihydrogen phosphate are respectively adjusted using disodium hydrogen phosphate•12-hydrate and sodium dihydrogen phosphate•2-hydrate, and the value of the blending ratio is converted by subtracting the water weight from the weight of the disodium hydrogen phosphate•12-hydrate.

Then, together with this packaging solution 14, using the soft contact lens 12 with a main component of 2-hydroxyethyl methacrylate the same as with the test noted above, these are sealed in the contact lens package 10, and storage testing was performed. As shown in Table 5 below, example 15 and example 16 have a fluid volume of 0.30 mL. The changes in pH when these were stored for 12 months or 15 months under conditions of temperature 25° C. and 45° C. are shown in Table 5 below. Also, these results are shown in FIG. 6 as a graph. This storage test is according to ISO 11987-1997, and the results of storage at 45° C. can be estimated to be roughly equal to the storage results for 4 times that period at room temperature (25° C.).

TABLE 5

| | Storage conditions | | | | | |
|---|---|---|---|---|---|---|
| | Fluid | Temper- | pH | | | |
| | volume | ature | Initial | After 6 | After 12 | After 15 |
| | (mL) | (° C.) | value | months | months | months |
| Example | 0.30 | 25 | 7.30 | 7.27 | 7.26 | — |
| 15 | | | | | | |
| Example | 0.30 | 45 | 7.30 | 7.20 | — | 6.89 |
| 16 | | | | | | |

As is clear from the results shown in Table 5 and FIG. 6, even after storage for 12 months at room temperature (25° C.) and 15 months at 45° C., the pH value of examples 15 and 16 had almost no change from the initial value. From these results of examples 15 and 16, if the present invention is followed, even when the fluid volume of the storage solution 14 is a small volume of 0.30 mL, it is possible to suppress the decrease in pH even after a long storage period of 12 months at room temperature (25° C.) and 15 months at 45° C., and we can see that it is possible to suppress the pH decrease range to be 0.5 or less from the initial value. Also, for the results of storage for 15 months for example 16 for which storage was performed at 45° C., this test is in accordance with the standards of ISO 11987-1997, so this can be estimated at roughly equal to storage for 60 months at room temperature (25° C.). Specifically, with the present invention, a solution with buffering capacity of 9 mmol/L is used. Therefore, even with the contact lens package 10 for which the fluid volume is 1.0 mL or less, and even after long term storage of 60 months at 25° C., we can see that it is possible to suppress the decrease in pH to 1.0 or less.

1. A contact lens distribution/storage method using a contact lens package in which are contained a packaging solution and a contact lens, wherein:
a soft contact lens is selected as the contact lens;
a fluid volume of the packaging solution is held within a range of 0.1 to 1.0 mL; and
a buffering capability of the packaging solution is arranged to have a buffering capacity of 3 mmol/L or greater.

2. The contact lens distribution/storage method according to claim 1, wherein the contact lens consists of a material that produces an acid component.

3. The contact lens distribution/storage method according to claim 1, wherein the packaging solution contains a buffering agent.

4. The contact lens distribution/storage method according to claim 3, wherein the buffering agent includes at least one of sodium dihydrogen phosphate, disodium hydrogen phosphate, boric acid, borax, and sodium hydrogen carbonate.

5. The contact lens distribution/storage method according to claim 3, wherein the buffering agent includes sodium chloride, sodium dihydrogen phosphate, and disodium hydrogen phosphate.

6. The contact lens distribution/storage method according to claim 1, wherein the packaging solution has a pH within a range of 5.5 to 8.0.

7. The contact lens distribution/storage method according to claim 1, wherein the packaging solution has a pH within a range of 6.0 to 7.5.

8. The contact lens distribution/storage method according to claim 1, wherein the packaging solution has a fluid volume within a range of 0.1 to 0.5 mL.

9. The contact lens distribution/storage method according to claim 1, wherein the packaging solution has the buffering capability of keeping a pH decrease of 1.0 or less during a distribution and storage period.

10. The contact lens distribution/storage method according to claim 1, wherein the contact lens package comprises two sheet layers front and back overlapping each other and sealed together to form therebetween a sealed container area, and the contact lens is contained within the container area while immersed in the packaging solution in a state compressionally deformed in a front and back direction between the two sheet layers.

11. The contact lens distribution/storage method according to claim 1, wherein the contact lens package comprises material.

12. A contact lens package that includes a packaging solution and a contact lens, wherein the improvement comprises:
a soft contact lens being selected as the contact lens;
a container area of the contact lens package having a capacity within a range of 0.1 to 1.0 mL excluding a volume of the contact lens; and
a solution having a buffering capacity of 3 mmol/L or greater being used as the packaging solution.

13. The contact lens package according to claim 12, wherein the contact lens package comprises two sheet layers front and back overlapping each other and sealed together to form therebetween a sealed container area, and the contact lens is contained within the container area while immersed in the packaging solution in a state compressionally deformed in a front and back direction between the two sheet layers.

14. The contact lens package according to claim 12, wherein the container area has a capacity within a range of 0.1 to 0.5 mL.

15. The contact lens package according to claim 12, wherein the contact lens consists of a material that produces an acid component.

16. The contact lens package according to claim 12, wherein the packaging solution contains a buffering agent.

17. The contact lens package according to claim 16, wherein the buffering agent includes at least one of sodium dihydrogen phosphate, disodium hydrogen phosphate, boric acid, borax, and sodium hydrogen carbonate.

18. The contact lens package according to claim 17, wherein the buffering agent includes sodium chloride, sodium dihydrogen phosphate, and disodium hydrogen phosphate.

19. The contact lens package according to claim 12, wherein the contact lens package comprises a sheet material.
